(19) United States
(12) Patent Application Publication
(10) Pub. No.: US 2024/0393279 A1
(43) Pub. Date: Nov. 28, 2024

(54) METHODS AND APPARATUS FOR MOISTURE DEGREE DETECTION

(71) Applicant: Intel Corporation, Santa Clara, CA (US)

(72) Inventors: Smit Kapila, Bangalore (IN); Jithin Valappilekandy, Bengaluru (IN); Prakash Kurma Raju, Bangalore (IN); Sean J. W. Lawrence, Bangalore (IN); Rachana T M, Bangalore (IN)

(21) Appl. No.: 18/323,731

(22) Filed: May 25, 2023

(51) Int. Cl. G01N 27/04; G06F 1/16; G08B 21/20

(52) U.S. Cl. CPC G01N 27/048; G06F 1/1656; G08B 21/20; G06F 1/1662

(57) ABSTRACT

Methods and apparatus for moisture degree detection are disclosed. An example apparatus for use with an input device includes trace routing positioned at or proximate a contact area of the input device, the trace routing including a first electrode, and a second electrode separated from the first electrode by a distance; and an amplifier electrically coupled to the first electrode and the second electrode, the amplifier to provide a signal based on a resistance related to a degree of moisture present between the first electrode and the second electrode.

### FIELD OF THE DISCLOSURE

This disclosure relates generally to computing devices and, more particularly, to methods and apparatus for moisture degree detection.

### BACKGROUND

Generally, consumer computing devices, such as personal computers (PCs) or laptops, are not waterproof or spill-proof (e.g., non IP67 standard compliant). For such computing devices, accidental spills can cause a short circuit in internal circuitry, thereby potentially resulting in permanent damage and malfunctions.

### BRIEF DESCRIPTION OF THE DRAWINGS

FIGS. 1A and 1B are schematic diagrams of an example moisture detection system in accordance with teachings of this disclosure.

FIG. 2 is a detailed view of a portion of an input device of the example moisture detection system of FIGS. 1A and 1B.

FIGS. 3A-3C depict example production of examples disclosed herein.

FIG. 4 is a block diagram of an example moisture analysis system that can be implemented in examples disclosed herein.

FIGS. 5 and 6 are flowcharts representative of example machine readable instructions and/or example operations that may be executed, instantiated, and/or performed by example programmable circuitry to implement the example moisture detection system of FIGS. 1A-2 and/or the example moisture analysis system of FIG. 4.

FIG. 7 is a block diagram of an example processing platform including programmable circuitry structured to execute, instantiate, and/or perform the example machine readable instructions and/or perform the example operations of FIGS. 5 and 6 to implement the example moisture detection system of FIGS. 1A-2 and/or the example moisture analysis system of FIG. 4.

FIG. 8 is a block diagram of an example implementation of the programmable circuitry of FIG. 7

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 5 and 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, or region) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

As used herein, the term “moisture” refers to a presence of vapor, condensed liquids liquid, a spill, droplets, etc. Accordingly, the term “moisture” can refer to liquid carried by air, droplets, drops, a puddle, a presence of liquid, etc.

### DETAILED DESCRIPTION

Methods and apparatus for moisture degree detection are disclosed. Input devices of computing devices, such as tablets, personal computers (PCs), laptops, etc., can be subject to exposure to liquids and/or moisture during normal operation. However, moisture carried by surrounding air can have a significantly different effect on exposed circuitry and/or electrical components in contrast to direct liquid contact (e.g., liquid spilled from a drink, rain drops falling on the computing device).

Examples disclosed herein can effectively determine a degree of moisture present in a computing device and/or an input device associated with or integrated as part of the computing device (e.g., a laptop keyboard). Examples disclosed herein can effectively determine a degree of moisture and/or liquid ingress. As a result, examples disclosed herein can enable corrective mitigation actions in a relatively quick manner for preventing permanent damage of the computing device and associated costs of repair and replacement. Examples disclosed herein can reduce costs of production and materials by not necessitating sealing and/or coatings that correspond to significant costs and/or production/labor time.

Examples disclosed herein can be implemented in a computing device or an input device (e.g., a mouse, a keyboard, a trackpad, etc.) associated with the computing device. In examples disclosed herein, a first electrode (e.g., a first trace) and a second electrode (e.g., a second trace) separate by a distance therebetween are implemented on trace routing (e.g., a trace routing path) at or proximate a contact area of a keyboard. In particular, the first and second electrodes and/or the trace routing can extend along a path that at least partially surrounds keys of the keyboards. The path can be at least partially defined by or accompany a trench, for example. In some examples, the first and second electrodes include embedded metal plating defined in a plastic matrix.

According to examples disclosed, an amplifier is electrically coupled to the aforementioned first and second electrodes. In particular, the amplifier provides and/or outputs a signal corresponding to a degree of moisture corresponding to electrical current moving between the first and second electrodes caused by moisture liquid present on or between the first and second electrodes. In other words, the amplifier is utilized to detect a degree of current and/or resistance between the first and second electrodes caused by moisture and/or liquid ingress. Particularly, examples disclosed herein can distinguish between moisture from the air (e.g., moisture due to air humidity) and degrees of liquid spilled onto/into the computing device and/or the input device. Accordingly, examples disclosed herein can mitigate liquid spilled while disregarding negligible or insignificant effects of relatively small spills, moisture from the air or small droplets (e.g., from rain) that may incidentally occur.

In some examples, a first mitigation action or a second mitigation action is selected based on the degree of moisture and/or liquid ingress (as measured via the aforementioned amplifier). In some such examples, the first mitigation action corresponds to immediately shutting down the computing device and/or the corresponding input device while, contrast, the second mitigation action corresponds to initiating a shutdown or standby sequence of the computing device (e.g., changing an operational mode of the computing device, initiating an operating system driven shutdown in contrast to directly cutting off power).

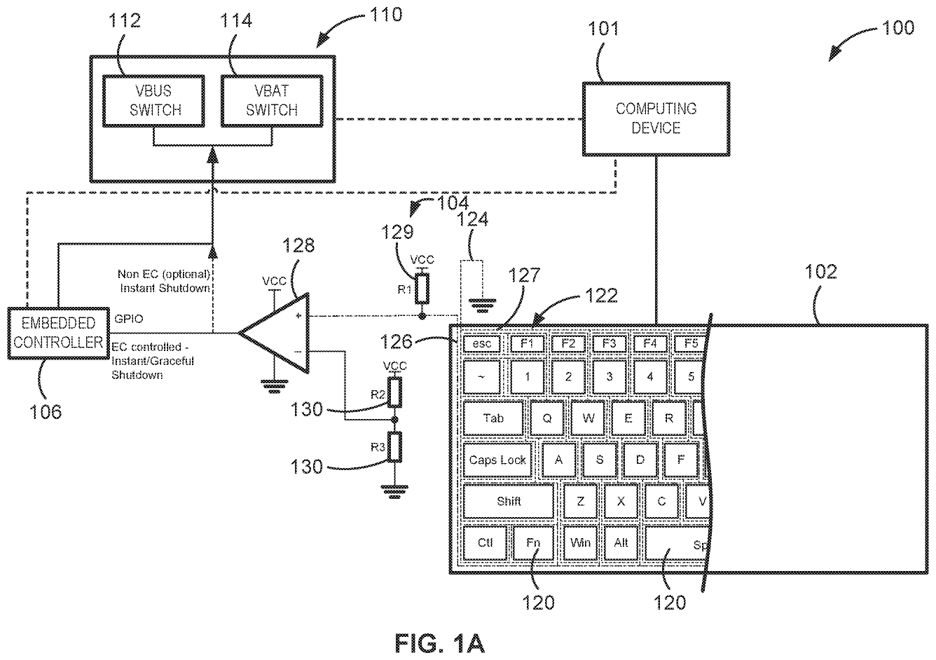

FIGS. 1A and 1B are schematic diagrams of an example moisture detection system 100 in accordance with teachings of this disclosure. Turning to FIG. 1A, the example moisture detection system 100 includes and/or is implemented in a computing device 101 (e.g., a PC, a tablet, a mobile phone, etc.) and/or an input device 102, which is implemented as a keyboard in this particular example. However, the example moisture detection system 100 can be implemented in any other appropriate type of input device, computing device and/or electronic device. In this example, the keyboard 102 includes and/or electrically/communicatively coupled to a circuit 104, as well as an embedded controller 106. In this example, the keyboard 102 includes and/or is communicatively coupled to a power/communication controller 110 which, in turn, includes a voltage bus switch 112 and a voltage battery switch 114. In some examples, the power/communication controller 110 can be implemented in the computing device 101.

The example keyboard 102 includes an array and/or arrangement of keys 120 that are actuated by a user to operate the computing device 101. Further, the example keys 120 are grouped/subdivided into meshes (e.g., sub-groups, groups, clusters, etc.) 122. In accordance with teachings of this disclosure, the keyboard 102 includes trace routing (e.g., parallel conductive paths, a routing path, a trace path, etc.) 124 that is routed proximate and/or around the keys 120.The example trace routing 124 is routed to at least partially surround (e.g., fully surround) ones of the keys 120. In other words, the trace routing 124 can be routed around peripheries of individual ones of the keys 120. In some such examples, the trace routing 124 is defined (e.g., printed, fabricated, plated etc.) onto a printed circuit board (PCB) and/or a dielectric substrate.

In this example, the trace routing 124 includes a first electrode 126 and a second electrode 127, both of which are separated by a distance from one another such that the distance can be generally constant (e.g., the spacing remains within 10%) along a length of the trace routing 124 or irregular such that spacing between the first electrode 126 and the second electrode 127 varies along length of the trace routing 124.

To detect a degree of moisture and/or liquid spillage in a contact area of the keyboard 102 that is on or proximate the keys 120, the circuit 104 of the illustrated example includes an amplifier 128 with the first electrode 126 and the second electrode 127 electrically coupled to a first input (e.g., a positive input) via a resistor 129. Further, the example amplifier 128 is electrically coupled to one or more resistors 130 at a second input thereof. In turn, an output of the example amplifier 128 is electrically coupled to the embedded controller 106 and/or the power/communication controller 110. In the illustrated example of FIG. 1A, moisture and/or liquid that is present between the first electrode 126 and the second electrode 127 causes an electrical current to be defined therebetween. In turn, the example amplifier 128 can indicate a degree of moisture and/or liquid ingress with its output. In other words, examples disclosed herein can advantageously determine a degree of moisture as opposed to simply determining a presence of moisture.

To mitigate moisture and/or liquid ingress that exceeds a threshold degree of moisture and/or liquid ingress, the example embedded controller 106 can determine and/or select an appropriate action for the keyboard 102 and/or the computing device 101 associated with the keyboard 102. According to examples disclosed herein, a moisture and/or liquid ingress that is less than a threshold degree of moisture and/or liquid ingress may be disregarded (e.g., the output of the amplifier 128 corresponds to moisture from the air or a small droplet near the keys 120). According to some examples disclosed herein, at least one of the meshes 122 having a degree of moisture and/or liquid ingress exceeding a threshold degree of moisture and/or liquid ingress is identified and/or determined such that the corresponding mesh(es) 122 can be identified (e.g., the identified mesh(es) 122) by the embedded controller 106 and/or the power/communication controller 110.

According to examples disclosed herein, the embedded controller 106 and/or the power/communication controller 110 may determine an action and/or power delivery curtailment based on the aforementioned degree of the moisture and/or liquid ingress. In particular, the embedded controller 106 and/or the power/communication controller 110 can compare the degree of the moisture and/or liquid ingress to a threshold degree of moisture and/or liquid ingress and select a first action or a second action, for example. The example first action can correspond to enabling the computing device 101 operatively coupled to the keyboard 102 to shutdown (e.g., initiate a shutdown sequence in an operating system). The example second action can correspond to directing a power supply or power circuit to immediately cease supplying power and/or current to the keyboard 102, thereby enabling shorts or other electrical events that could damage electrical components to be mitigated and/or prevented. Additionally or alternatively, an external power source is prevented from supplying the keyboard 102 with power.

In this example, the resistors 129, 130 each are valued at 10,000 ohm (Ω). However, any other appropriate resistor values and/or resistor arrangement can be implemented instead. In some examples, the computing device 101 is communicatively coupled to the embedded controller 106 and/or the power/communication controller 110 (in addition to being communicatively coupled to circuitry and/or processor circuitry of the keyboard 102). Further, while the example of FIG. 1A is shown in the context of the keyboard 102, examples disclosed herein can be applied to any appropriate type of input device, mobile device and/or computing device.

FIG. 1B depicts how multiple zones or meshes can be analyzed in examples disclosed herein. In this example, multiple ones of the meshes 122 (designated as meshes 122a, 122b, 122c, 122d, etc.) are implemented across the keyboard 102, and each include a corresponding circuit 104 (designated as circuits 104a, 104b, 104c, 104d, etc.). In the illustrated example of FIG. 1B, the circuits 104a, 104b, 104c, 104d are each electrically coupled to the embedded controller 106 and/or the power/communication controller 110.

In this example, the embedded controller 106 and/or the power/communication controller 110 determine and/or identify which of the circuits 104 and/or the meshes 122 are experiencing moisture and/or liquid ingress that exceeds a threshold degree of moisture and/or liquid ingress. Accordingly, some examples disclosed herein can determine a location of a spill and/or liquid ingress. In some examples, a size of the spill can be determined. In some such examples, the embedded controller 106 and/or the power/communication controller 110 can apply different mitigation actions and/or no mitigation action to individual ones of the meshes 122. For example, in a scenario where the mesh 122a experiences moisture and/or liquid ingress that exceeds a threshold level of moisture and/or liquid ingress while the mesh 122b does not, the keys 120 associated with the mesh 122a are rendered inoperable, disconnected from power/current and/or made inactive while the keys 120 associated with the mesh 122b are enabled to operate and/or detect/register keystrokes thereof. In other examples, the embedded controller 106 and/or the power/communication controller 110 can control individual ones of the keys 120 based on moisture/liquid ingress thereof. In some examples, a logic gate (e.g., a NOR gate) 140 is implemented for control of the power/communication controller 110 such that the power can be shut down immediately upon any of the meshes 122 encountering moisture and/or liquid ingress.

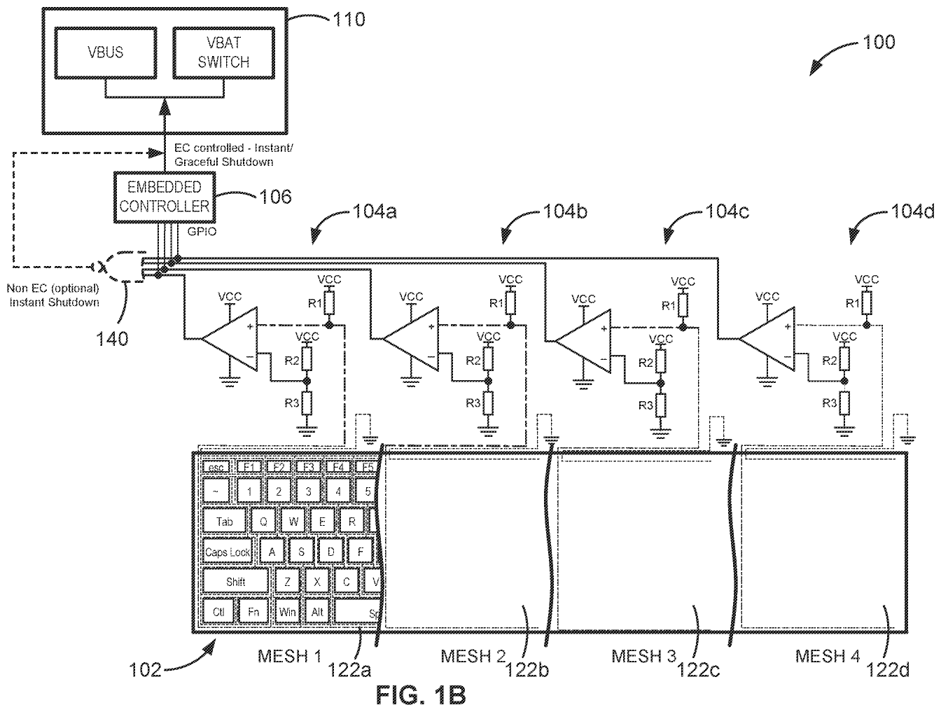

FIG. 2 is a detailed view of a portion 200 of the example keyboard 102 of the example moisture detection system 100 of FIGS. 1A and 1B. As can be seen in FIG. 2, each of the keys 120 are surrounded by the trace routing 124 along which the electrodes 126, 127 of FIG. 1A extend. In particular, the electrodes 126, 127 extend along pathways of the trace routing 124, but are generally separated by a constant distance therebetween. In other examples, the electrodes 126, 127 are separated by varying distances between one another. In some examples, each of the meshes 122 shown in FIGS. 1A and 1B includes a corresponding one of the trace routing 124. In some examples, a trough, groove and/or channel is utilized to facilitate and/or cause liquid to move toward the electrodes 126, 127 (e.g., by surface tension or gravity, etc.). In some examples, the electrodes 126, 127 and/or the trace routing 124 at least partially define an aesthetic portion/section (e.g., a logo, a design, an indicator, a label, etc.) of the keyboard 102.

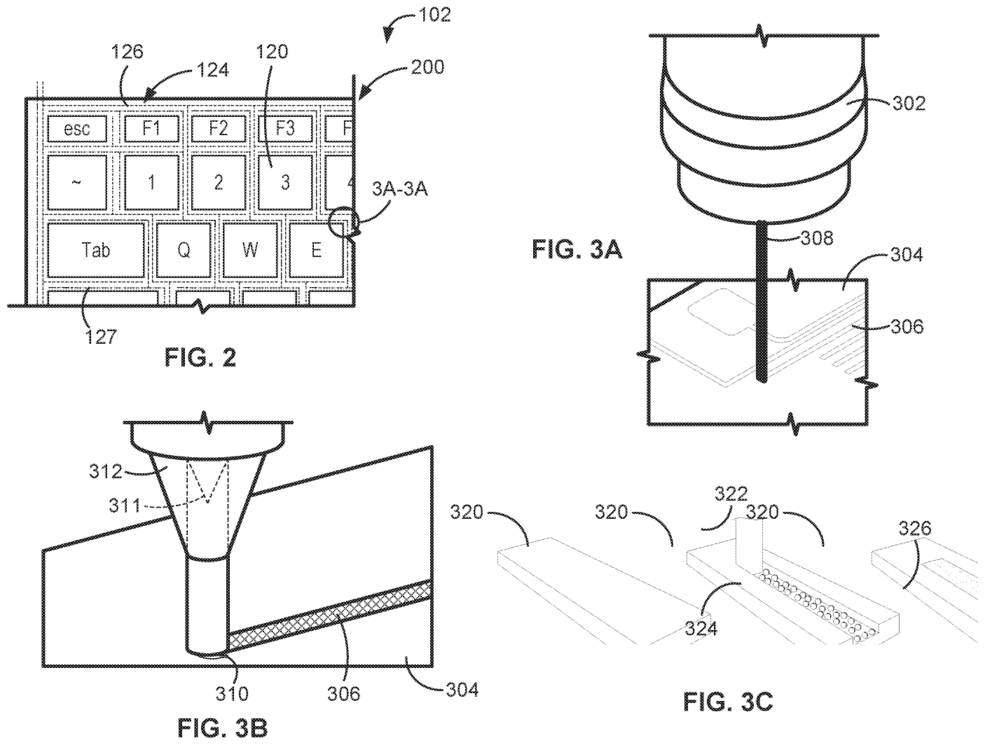

FIGS. 3A-3C depict example production of examples disclosed herein. FIGS. 3A and 3B depict a utilization of a laser direct sintering (LDS) to define the electrodes 126, 127 shown in FIGS. 1A-2. Turning to FIG. 3A, a laser 302 is directed toward a substrate (e.g., a dielectric substrate, a non-conductive substrate, etc.) 304. As depicted in the example of FIG. 3A, the substrate 304 is defined with a route 306 (e.g., a groove, trench) thereon defined by a laser (e.g., a laser beam) 308 emitted from the laser 302.

FIG. 3B depicts deposition of a powder stream 311 to define a melt pool 310 placed onto the route 306. In the illustrated example of FIG. 3B, the powder stream 311 passes through a nozzle (e.g., a nozzle dispenser) 312. In this example, a powder bed is defined onto the route 306 as the nozzle 312 is moved relative to the substrate 304, thereby defining an electrode and/or routed trace.

FIG. 3C depicts plating of a plastic substrate 320, which is injection molded in this example. According to examples disclosed herein, the substrate 320 is irradiated via laser irradiation with a beam 322 to define a coarse section or portion 324. In this example, the coarse section 324 is activated and, thus, forms a plating catalyst. In turn, plating 326 is formed on, deposed onto and/or defined onto the substrate 320, thereby defining an electrode and or routed trace. Examples methods of production/processing of FIGS. 3A-3B are non-limiting examples, and any other appropriate manufacturing methodology and/or implementation can be implemented instead.

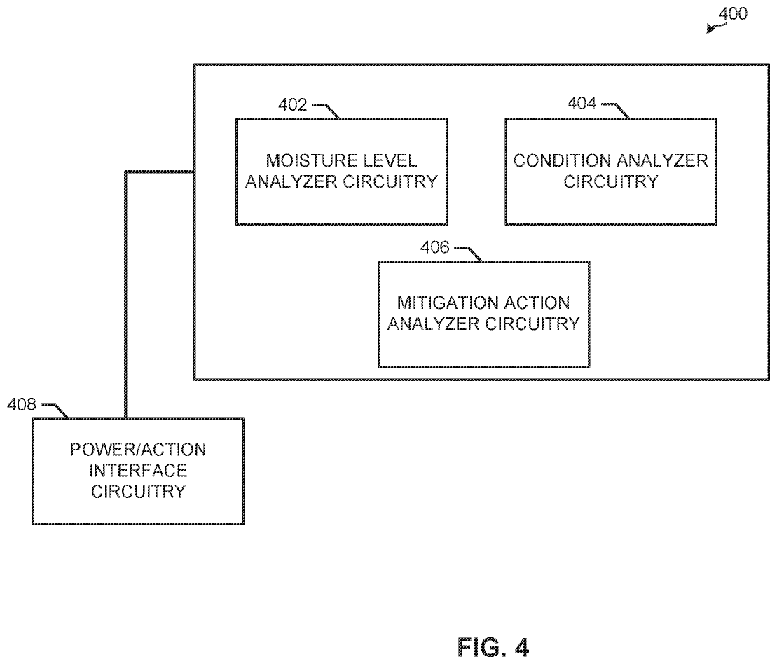

FIG. 4 is a block diagram of an example implementation of the moisture detection system 100 of FIGS. 1A and 1B to determine a degree of liquid/moisture intrusion and control and/or direct mitigation actions based on the degree of liquid/moisture intrusion. An example moisture analysis system 400 of FIG. 4 can be implemented in the embedded controller 106 and/or the power/communication controller 110 shown in FIGS. 1A and 1B. The example moisture analysis system 400 may be instantiated (e.g., creating an instance of, bring into being for any length of time, materialize, implement, etc.) by programmable circuitry such as a Central Processor Unit (CPU) executing first instructions. Additionally or alternatively, the moisture analysis system 400 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

As can be seen in the illustrated example of FIG. 4, the aforementioned example moisture analysis system 400 includes example moisture level analyzer circuitry 402, example condition analyzer circuitry 404, example mitigation action analyzer circuitry 406, and example power/action interface circuitry 408.

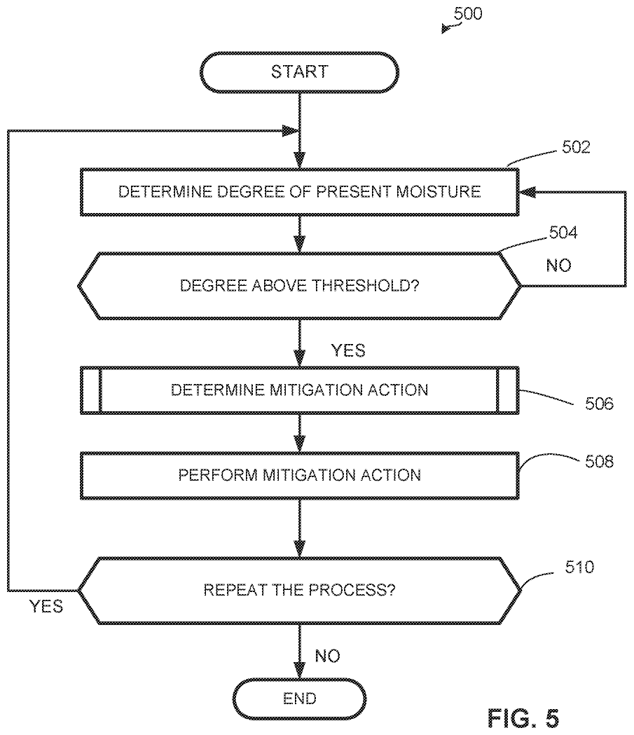

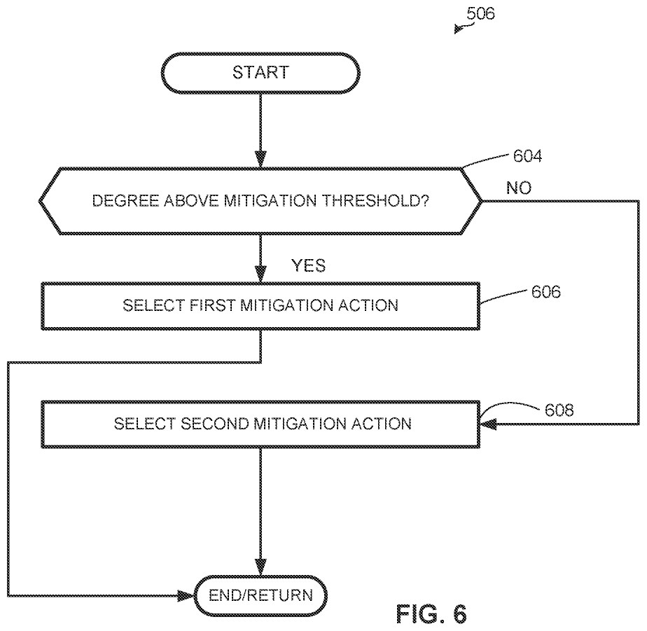

The example moisture level analyzer circuitry 402 is implemented to determine a degree to which liquid and/or moisture is present in an input device (e.g., the keyboard 102) and/or a computing device (e.g., the computing device 101). In this example, the degree to which liquid and/or moisture is present is determined by the example moisture level analyzer circuitry 402 at least partially based on an output of an amplifier (e.g., the amplifier 128) that is electrically coupled to electrodes (e.g., the electrodes 126, 127) separated by a distance and/or gap. According to examples disclosed herein, a first scenario, in which no detectable moisture present (e.g., a dry condition) can correspond to a resistance between the electrodes of approximately 1,000,0000 Ω, and, thus, the amplifier can output a relatively high magnitude signal. In a second scenario, sweaty hands of a user can result in a resistance between the electrodes of approximately 100,000 Ω with a corresponding amplifier output having a relatively high magnitude signal. In contrast, in a third scenario, spilling water onto the electrodes can result in a resistance between the electrodes of approximately 20,000 Ω, thereby resulting in a relatively low magnitude signal from the amplifier. The example resistances and amplifier output are only examples and any appropriate values and/or parameters can be implemented instead. In some examples, the moisture level analyzer circuitry 402 is instantiated by programmable circuitry executing moisture level analyzer instructions and/or configured to perform operations such as those represented by the flowcharts of FIGS. 5 and 6.

In this example, the condition analyzer circuitry 404 determines a condition (e.g., a liquid/moisture ingress condition) of the input device and/or at least one mesh or area of the input device. According to examples disclosed herein, the condition analyzer circuitry 404 determines the condition by comparing the output of the amplifier exceeds a threshold output (e.g., a threshold output that corresponds to liquid ingress/spillage, etc.) to determine the condition. In some examples, the condition analyzer circuitry 404 is instantiated by programmable circuitry executing condition analyzer instructions and/or configured to perform operations such as those represented by the flowcharts of FIGS. 5 and 6.

The example mitigation action analyzer circuitry 406 is implemented to determine and/or select a mitigation action based on the condition determined by the condition analyzer circuitry 404. In some examples, the mitigation action analyzer circuitry 406 selects a first mitigation action associated with shutting down the input device or a second mitigation action associated with causing and/or directing a computing device communicatively coupled to the input to device to shutdown (e.g., initiating a shutdown procedure in an operating system of the computing device, initiating a sleep mode with the operating system of the computing device, etc.). However, any other appropriate mitigation actions and/or mitigation sequences can be implemented instead. In some examples, the mitigation action analyzer circuitry 406 is instantiated by programmable circuitry executing mitigation action analyzer instructions and/or configured to perform operations such as those represented by the flowcharts of FIGS. 5 and 6.

In the illustrated example of FIG. 4, the power/action interface circuitry 408 directs the embedded controller 106, the voltage bus switch 112 and/or the voltage battery switch 114 to perform the mitigation action selected and/or determined by the mitigation action analyzer circuitry 406. In this example, the voltage bus switch 112 controls power received from a power adapter (e.g., a wall plug adapter) while the voltage battery switch 114 controls power received from a battery. According to examples disclosed herein, the power/action interface circuitry 408 can also instruct or cause the computing device (e.g., an operating system of the computing device, power circuitry of the computing device, etc.) to perform the mitigation action (e.g., cease power from the voltage bus switch 112, cease power from the voltage battery switch 114, etc.). The mitigation action can be performed to protect a motherboard of the computing device 101, for example. In some examples, the power/action interface circuitry 408 is instantiated by programmable circuitry executing power/action interface instructions and/or configured to perform operations such as those represented by the flowcharts of FIGS. 5 and 6.

While an example manner of implementing the moisture analysis system 400 of FIG. 4 is illustrated in FIG. 4, one or more of the elements, processes, and/or devices illustrated in FIG. 4 may be combined, divided, re-arranged, omitted, eliminated, and/or implemented in any other way. Further, the example moisture level analyzer circuitry 402, the example condition analyzer circuitry 404, the example mitigation action analyzer circuitry 406, the example power/action interface circuitry 408, and/or, more generally, the example moisture analysis system 400 of FIG. 4, may be implemented by hardware alone or by hardware in combination with software and/or firmware. Thus, for example, any of the example moisture level analyzer circuitry 402, the example condition analyzer circuitry 404, the example mitigation action analyzer circuitry 406, the example power/action interface circuitry 408, and/or, more generally, the example moisture analysis system 400, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example moisture analysis system 400 of FIG. 4 may include one or more elements, processes, and/or devices in addition to, or instead of, those illustrated in FIG. 4, and/or may include more than one of any or all of the illustrated elements, processes and devices.

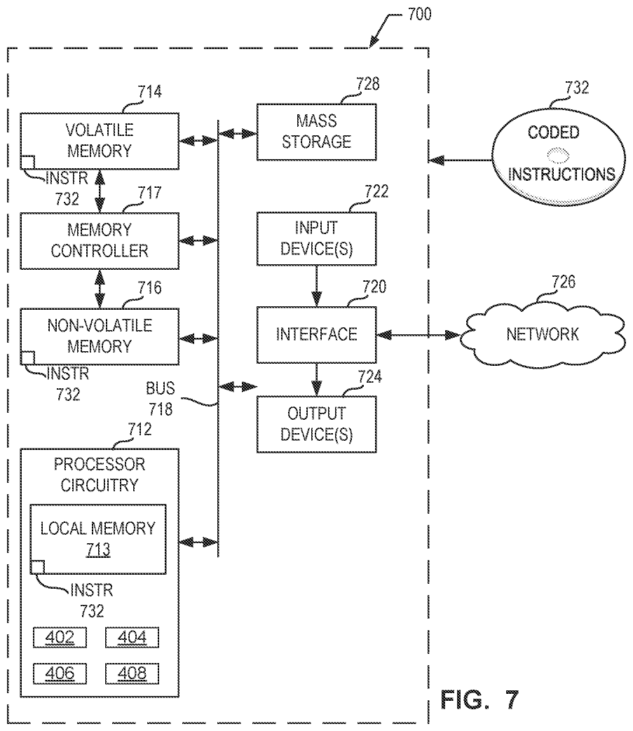

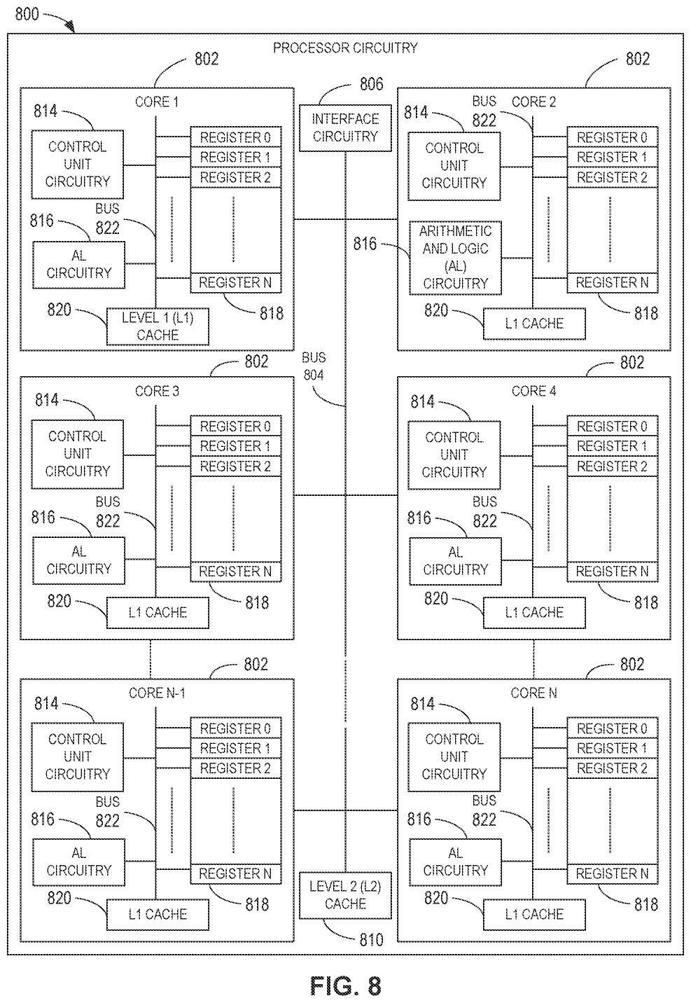

Flowcharts representative of example machine readable instructions, which may be executed by programmable circuitry to implement and/or instantiate the moisture analysis system 400 of FIG. 4 and/or representative of example operations which may be performed by programmable circuitry to implement and/or instantiate the moisture analysis system 400 of FIG. 4, are shown in FIGS. 5 and 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 5 and 6, many other methods of implementing the example moisture analysis system 400 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5 and 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed, instantiated, and/or performed by programmable circuitry to determine a degree of moisture/liquid ingress and to select and/or perform a mitigation action. The example machine-readable instructions and/or the example operations 500 of FIG. 5 begin at block 502, at which the example moisture level analyzer circuitry 402 determines a degree of present moisture, spillage and/or liquid ingress with respect to an input device (e.g., the keyboard 102). In this example, the degree of present moisture and/or liquid ingress is based on an output of an amplifier electrically coupled to electrodes of the input device such that the electrodes are separated by a gap and/or distance (e.g., electrodes spaced apart on a circuit board and/or substrate). The gap and/or the distance can vary across the input device or, alternatively, can remain relatively constant between the electrodes (e.g., within 10% of the spacing distance).

At block 504, the example condition analyzer circuitry 404 determine whether the degree of present moisture and/or liquid ingress meets or exceeds a threshold value. If the degree of present moisture and/or liquid ingress meets or exceeds the threshold value (block 504), control of the process proceeds to block 506. Otherwise, the process returns to block 502. In some examples, the condition analyzer circuitry 404 determines whether there is liquid present based on the comparison to the aforementioned threshold value. Additionally or alternatively, the condition analyzer circuitry 404 determines a position/location of a spill based on identifying a mesh having liquid present. Additionally or alternatively a size of the spill is determined by the condition analyzer circuitry 404 based on the output of the amplifier.

At block 506, in the illustrated example of FIG. 5, the mitigation action analyzer circuitry 406 determines and/or selects at least one mitigation action based on whether the degree of present moisture and/or liquid ingress meets or exceeds a threshold value. According to some examples disclosed herein, the migration action can be determined and/or selected from multiple mitigation actions (e.g., an array of mitigation actions).

At block 508, the example power/action interface circuitry 408 performs the determined and/or selected mitigation action. In some examples, the power/action interface circuitry 408 performs a sequence of mitigation actions.

At block 510, in some examples, the condition analyzer circuitry 404 and/or the mitigation action analyzer circuitry 406 determines whether to repeat the process. If the process is to be repeated (block 510), control of the process returns to block 502. Otherwise, the process ends.

FIG. 6 is a flowchart representative of the example machine readable instructions and/or example operations 506 that may be executed, instantiated, and/or performed by programmable circuitry to determine and/or select a mitigation action. The example machine-readable instructions and/or the example operations 506 of FIG. 6 begin at block 604, at which the mitigation action analyzer circuitry 406 determines whether a degree of moisture or liquid ingress meets or exceeds a mitigation threshold. If the mitigation action analyzer circuitry 406 determines that the degree of moisture or liquid intrusion meets or exceeds the mitigation threshold (block 604), control of the process proceeds to block 606. Otherwise, the process proceeds to block 608.

At block 606, the mitigation action analyzer circuitry 406 selects a first mitigation action and the process ends/returns.

At block 608, the mitigation action analyzer circuitry 406 selects a second mitigation action different from the first mitigation action and the process ends/returns.

FIG. 7 is a block diagram of an example programmable circuitry platform 700 structured to execute and/or instantiate the example machine-readable instructions and/or the example operations of FIGS. 5 and 6 to implement the moisture analysis system 400 of FIG. 4. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example moisture level analyzer circuitry 402, the example condition analyzer circuitry 404, the example mitigation action analyzer circuitry 406, and the example power/action interface circuitry 408.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 5 and 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 5 and 6 to effectively instantiate the circuitry of FIG. 4 as logic circuits to perform operations corresponding to those machine readable instructions. In some such examples, the circuitry of FIG. 4 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5 and 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (12C) bus, a Serial Peripheral Interface (SPI) bus, a PCI bus, or a PCle bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

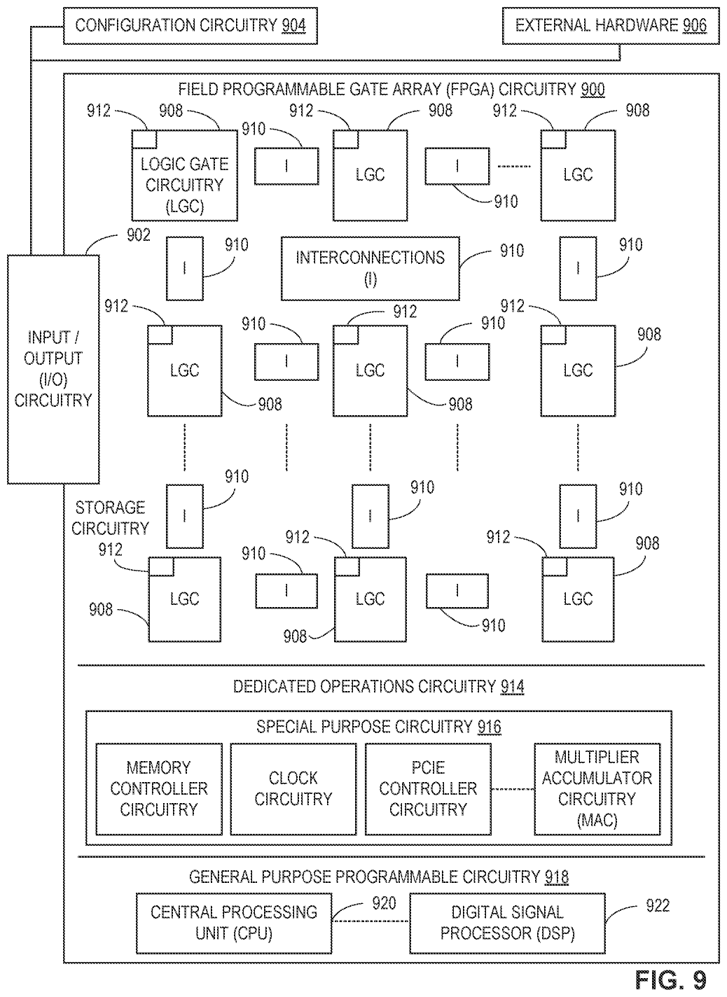

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 5 and 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 5 and 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 5 and 6. As such, the FPGA circuitry 900 may be configured and/or structured to effectively instantiate some or all of the operations/functions corresponding to the machine readable instructions of the flowcharts of FIGS. 5 and 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 5 and 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 5 and 6 and/or other desired operations. The logic gate circuitry 908 shown in FIG. 9 is fabricated in blocks or groups.

Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCle controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowcharts of FIGS. 5 and 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 5 and 6, and/or an ASIC may be configured and/or structured to perform third operation(s)/function(s) corresponding to a third portion of the machine readable instructions represented by the flowcharts of FIGS. 5 and 6.

It should be understood that some or all of the circuitry of FIG. 4 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 4 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

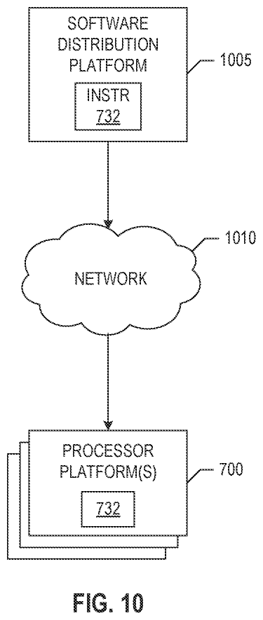

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 5 and 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 5 and 6, may be downloaded to the example programmable circuitry platform 700, which is to execute the machine readable instructions 732 to implement the moisture analysis system 400. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

Example methods, apparatus, systems, and articles of manufacture to enable effective leak condition determinations and appropriate mitigation actions are disclosed herein. Further examples and combinations thereof include the following:

Example 1 includes an apparatus for use with an input device, the apparatus comprising trace routing positioned at or proximate a contact area of the input device, the trace routing including a first electrode, and a second electrode separated from the first electrode by a distance, and an amplifier electrically coupled to the first electrode and the second electrode, the amplifier to provide a signal based on a resistance related to a degree of moisture present between the first electrode and the second electrode.

Example 2 includes the apparatus as defined in example 1, further including machine readable instructions, and programmable circuitry to at least one of instantiate or execute the machine readable instructions to determine the degree of moisture based on the signal, compare the degree of moisture to a threshold degree of moisture, and cause a mitigation action to be performed based on the comparison.

Example 3 includes the apparatus as defined in example 2, wherein the programmable circuitry to at least one of instantiate or execute the machine readable instructions to select a first mitigation action or a second mitigation to be performed based on the degree.

Example 4 includes the apparatus as defined in example 3, wherein the first mitigation action corresponds to removing power to the input device or a computing device associated with the input device, and wherein the second mitigation action corresponds to changing an operational mode of at least one of the input device or the computing device.

Example 5 includes the apparatus as defined in any of examples 1 to 4, wherein the input device includes a keyboard.

Example 6 includes the apparatus as defined in example 5, wherein the trace routing extends along a path that at least partially surrounds at least one of the keys of the keyboard.

Example 7 includes the apparatus as defined in example 6, wherein the path surrounds peripheries of the keys of the keyboard.

Example 8 includes the apparatus as defined in any of examples 1 to 7, wherein the first and second electrodes each include laser direct sintering traces on a substrate.

Example 9 includes the apparatus as defined in any of examples 1 to 7, wherein the first and second electrodes each include metal plating embedded in a plastic matrix.

Example 10 includes the apparatus as defined in examples 1 to 9, wherein the input device includes a mouse or a trackball.

Example 11 includes a non-transitory machine readable storage medium comprising instructions to cause programmable circuitry to at least determine a degree of moisture present in a contact area of an input device based on a signal from an amplifier electrically coupled to first and second electrodes, the first and second electrodes extending along trace routing at or close to the contact area, the first and second electrodes separated by a distance therebetween, compare the degree of moisture to a threshold degree of moisture, and cause a mitigation action to be performed in response to the degree of moisture exceeding the threshold degree of moisture.

Example 12 includes the non-transitory machine readable storage medium as defined in example 11, wherein the instructions cause the programmable circuitry to select a first mitigation action or a second mitigation to be performed based on the degree of moisture.

Example 13 includes the non-transitory machine readable storage medium as defined in example 12, wherein the first mitigation action corresponds to removing power to the input device or a computing device associated with the input device, and wherein the second mitigation action corresponds to changing an operational mode of at least one of the input device or the computing device.

Example 14 includes the non-transitory machine readable storage medium as defined in any of examples 11 to 13, wherein the instructions cause the programmable circuitry to cause the mitigation action to be performed by disabling keys associated with a mesh having the first and second electrodes.

Example 15 includes the non-transitory machine readable storage medium as defined in example 14, wherein the mesh is a first mesh, and wherein the instructions cause the programmable circuitry to disable keys of the first mesh while enabling keys of a second mesh to operate.

Example 16 includes the non-transitory machine readable storage medium as defined in any of examples 11 to 13, wherein the instructions cause the programmable circuitry to cause the mitigation action by initiating a shutdown sequence of a computing device associated with or including the input device.

Example 17 includes the non-transitory machine readable storage medium as defined in any of examples 11 to 13, wherein the instructions cause the programmable circuitry to cause the mitigation action by shutting power off to the input device.

Example 18 includes the non-transitory machine readable storage medium as defined in any of examples 11 to 17, wherein the instructions cause the programmable circuitry to determine whether the degree of moisture is caused by a spill of liquid onto the input device.

Example 19 includes the non-transitory machine readable storage medium as defined in example 18, wherein the instructions cause the programmable circuitry to determine a location or size of the spill.

Example 20 includes a method comprising determining, by executing instructions with processor circuitry, a degree of moisture present in a contact area of an input device based on a signal from an amplifier electrically coupled to first and second electrodes, the first and second electrodes extending along trace routing at or proximate the contact area, the first and second electrodes separated by a distance therebetween, comparing, by executing instructions with the processor circuitry, the degree of moisture to a threshold degree of moisture, and causing, by executing instructions with the processor circuitry, a mitigation action to be performed in response to the degree of moisture exceeding the threshold degree of moisture.

From the foregoing, it will be appreciated that example systems, apparatus, articles of manufacture, and methods have been disclosed that enable effective determination of liquid and/or moisture intrusion into a computing device and/or an associated input device of the computing device. Examples disclosed herein can effectively determine a degree of moisture and/or liquid ingress and enable corrective mitigation actions that can prevent permanent damage of the computing device, thereby preventing device loss (and associated costs). Examples disclosed herein enable effective selection of a mitigating action and, thus, tailor an appropriate response based on a severity. Examples disclosed herein can be cost-effectively produced by reducing a need for waterproofing or other relatively expensive measures, as commonly done in current systems.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus for use with an input device, the apparatus comprising:
trace routing positioned at or proximate a contact area of the input device, the trace routing including:
a first electrode, and
a second electrode separated from the first electrode by a distance; and
an amplifier electrically coupled to the first electrode and the second electrode, the amplifier to provide a signal based on a resistance related to a degree of moisture present between the first electrode and the second electrode.

2. The apparatus as defined in claim 1, further including:
machine readable instructions; and
programmable circuitry to at least one of instantiate or execute the machine readable instructions to:
determine the degree of moisture based on the signal;
compare the degree of moisture to a threshold degree of moisture, and
cause a mitigation action to be performed based on the comparison.

3. The apparatus as defined in claim 2, wherein the programmable circuitry to at least one of instantiate or execute the machine readable instructions to select a first mitigation action or a second mitigation to be performed based on the degree.

4. The apparatus as defined in claim 3, wherein the first mitigation action corresponds to removing power to the input device or a computing device associated with the input device, and wherein the second mitigation action corresponds to changing an operational mode of at least one of the input device or the computing device.

5. The apparatus as defined in claim 1, wherein the input device includes a keyboard.

6. The apparatus as defined in claim 5, wherein the trace routing extends along a path that at least partially surrounds at least one of the keys of the keyboard.

7. The apparatus as defined in claim 6, wherein the path surrounds peripheries of the keys of the keyboard.

8. The apparatus as defined in claim 1, wherein the first and second electrodes each include laser direct sintering traces on a substrate.

9. The apparatus as defined in claim 1, wherein the first and second electrodes each include metal plating embedded in a plastic matrix.

10. The apparatus as defined in claim 1, wherein the input device includes a mouse or a trackball.

11. A non-transitory machine readable storage medium comprising instructions to cause programmable circuitry to at least:
determine a degree of moisture present in a contact area of an input device based on a signal from an amplifier electrically coupled to first and second electrodes, the first and second electrodes extending along trace routing at or close to the contact area, the first and second electrodes separated by a distance therebetween;
compare the degree of moisture to a threshold degree of moisture; and
cause a mitigation action to be performed in response to the degree of moisture exceeding the threshold degree of moisture.

12. The non-transitory machine readable storage medium as defined in claim 11, wherein the instructions cause the programmable circuitry to select a first mitigation action or a second mitigation to be performed based on the degree of moisture.

13. The non-transitory machine readable storage medium as defined in claim 12, wherein the first mitigation action corresponds to removing power to the input device or a computing device associated with the input device, and wherein the second mitigation action corresponds to changing an operational mode of at least one of the input device or the computing device.

14. The non-transitory machine readable storage medium as defined in claim 11, wherein the instructions cause the programmable circuitry to cause the mitigation action to be performed by disabling keys associated with a mesh having the first and second electrodes.

15. The non-transitory machine readable storage medium as defined in claim 14, wherein the mesh is a first mesh, and wherein the instructions cause the programmable circuitry to disable keys of the first mesh while enabling keys of a second mesh to operate.

16. The non-transitory machine readable storage medium as defined in claim 11, wherein the instructions cause the programmable circuitry to cause the mitigation action by initiating a shutdown sequence of a computing device associated with or including the input device.

17. The non-transitory machine readable storage medium as defined in claim 11, wherein the instructions cause the programmable circuitry to cause the mitigation action by shutting power off to the input device.

18. The non-transitory machine readable storage medium as defined in claim 11, wherein the instructions cause the programmable circuitry to determine whether the degree of moisture is caused by a spill of liquid onto the input device.

19. The non-transitory machine readable storage medium as defined in claim 18, wherein the instructions cause the programmable circuitry to determine a location or size of the spill.

20. An apparatus comprising
means for determining a degree of moisture present in a contact area of an input device based on a signal from an amplifier electrically coupled to first and second electrodes, the first and second electrodes extending along trace routing at or proximate the contact area, the first and second electrodes separated by a distance therebetween;
means for comparing the degree of moisture to a threshold degree of moisture; and
means for causing a mitigation action to be performed in response to the degree of moisture exceeding the threshold degree of moisture.
